(19) United States
(12) Patent Application Publication
(10) Pub. No.: US 2021/0144918 A1
(43) Pub. Date: May 20, 2021

(54) Mill the Weed Seed in Grain Combines

(71) Applicant: Roger L. Elgersma, Pipestone, MN (US)

(72) Inventor: Roger L. Elgersma, Pipestone, MN (US)

(21) Appl. No.: 16/686,546

(22) Filed: Nov. 18, 2019

(51) Int. Cl. A01D 41/12

(52) U.S. Cl. CPC A01D 41/1243

(57) ABSTRACT

My invention to “Mill the Weed Seed from Grain Combines” will kill much of the weed seed that would have been available the next year by milling (grinding) it. Mainly, this will reduce the weed seed and secondarily it could also reduce the volume of poisonous chemical herbicides that will be needed to control weeds in crops.

The title of my invention is “Mill the Weed Seed in Grain Combines”.

I Roger L. Elgersma did all the research and development, thinking and analyzing to create the ideas, testing of ideas, buying supplies to test different mill types and used differing seed types to research how to make a mill that would get the job done in this application. No one else participated in this process.

### BACKGROUND OF THE INVENTION

I am not sure exactly when I first thought of this idea, but it was in the first half of 2017, because that summer I was on a bicycle ride and saw a John Deere 9500 combine which was perfectly adaptable to my idea. I had noticed that there were more fields that had almost no weeds than when I was a child and that is probably because more chemical herbicides are used today. The John Deere 9500 had a chaff spreader. It already separated out the weed seed and then spread it on the ground. The chaff spreader had a hydraulic motor turning the chaff spreader. The hydraulic motor could easily turn a burr mill to grind the weed seed instead of just spreading it out on the ground. I thought about this idea from time to time and did a little research on mills.

There are large industrial mills from $30,000 and up and there were household coffee grinders, but nothing the right size for a combine. There were also small grain mills for making flour at home or cracking barley to make homebrew beer and mills that grind peanuts into peanut butter. Some of these were not built with tight enough specs and some could not be adjusted properly to get a fine grind (particle size).

Then I decided to experiment with milling weed seed with a smaller burr mill with the plan to put two to four small burr mills on the back of a combine and run all at the same time.

The one that makes peanut butter was necessary to mill wet weed seed because it had an auger that forced the material through so it would not plug up with wet goo. At this point I have experimented with different types of seed. Those not milled grow and none grow from the particles after the seeds have been milled. So, the milling works well when set to the correct particle size.

### BRIEF SUMMARY OF THE INVENTION

The utility patent I am applying for will mill (grind) the weed seed that comes out of a grain harvester with a burr mill. Combines (grain harvesters) to date just spread the weed seed back on the field along with the straw and keep the grain.

### DETAILED DESCRIPTION OF THE INVENTION

“Mill the Weed Seed in Grain Combines” will be the last process that happens in the grain combine before discharging the chaff back onto the field. In the harvester there are a set of two sieves. Above the sieves are straw walkers which take out the largest materials such as stems, branches, stalks, husks, and leaves of both the intended grain crop and of the weeds that come through the combine. These large objects of the grain and weed plants are called trash. The trash typically goes out the upper part of the back of the combine. The grain and everything smaller falls through the first sieve. The second sieve sorts out the small stuff which is smaller than the grain which is mostly chaff and weed seed. This part of the waste typically goes out the lower part of the back of the combine. The light chaff blows out with a fan. The mill to grind the weed seed will be at the lower rear of the combine where the weed seed normally falls out of the machine. There should be a hopper there to catch the weed seed and chaff because where there is a large thick weed patch, the weed seed might accumulate faster than the mill could handle it. This will act as reserve storage to make it possible to get all the weed seed milled without overflowing to the ground first. This hopper would also be a very handy spot to check if the combine is set properly. If it is not set properly some kernels of grain might be going back to the ground rather than to the grain tank. By looking at what comes out of the combine at that point is the best place to check both if the cylinder is set right and if the sieves are set right to do a quality job of harvesting the crop. The mill could be shut off temporarily to test this.

When combining corn, most of the weed plant does not go through the combine. But with any crop where the crop is cut off at the ground with a sickle, such as soybeans and small grain, the crop and weeds all go through the combine. “Mill the Weed Seed in Grain Combines” would be effective only with crops that are cut off with a sickle.

The weed seed is typically smaller than the grain being harvested. My invention would catch the weed seed and other chaff in this area and mill it fine enough that the seeds would not grow the following year. This requires grinding it approximately to flour. Some seeds are very small, so a rather fine grind (particle size) is required. An example of a very tiny seed is Amaranth. They need to be milled down to powder to kill all of them.

The mill will need an auger to force the weed seed into the mill. When grain is harvested before frost, the weed seeds tend to be a bit wet. This plugs up the mill if it is not forced through. When the weed seed is dry, it tends to flow through on its own. Forcing it through speeds up the process either way.

When I first looked up burr mills on the internet, I only found large industrial mills and tiny home coffee grinders. There was nothing in the size range which would be good for a grain combine.

Four types of mills were used in my experiments. First the Corn grinder which had far too loose of specs so that it could not mill anything smaller than a kernel of corn. Then the Monster Mill2 which would not adjust close enough. They did have another unit with three rollers which could adjust closer to break small seeds. Then I used the Country Living Grain Mill. I also used the peanut attachment which was necessary when the weed seed was wet. The auger pushed it through so that at a more open setting it would make peanut butter, but with weed seed, it needs a larger mill for that volume of input because it needed a much tighter setting to mill small weed seed. Smaller particle size coming out of the mill produces a slower rate of milling. So, a larger mill is needed when forcing through a large volume of weed seed. This was very hard to turn with that rate of volume. When manufacturing a burr mill to kill weed seed in a combine it will be necessary to size the auger pushing it in with the volume of capacity of the burr plates and the amount of material that will have to go through to be milled. This will have to be sized according to the size of the combine. I have done enough experimenting to know it can be done.

1. The weed seed and some small heavy particles, other than chaff, come through the bottom sieve on a grain combine. From there it will slide into the hopper of the mill and then augered into the mill(grinder) to grind the weed seed approximately to flour. The mill has two ribbed discs that mill the material consisting of weed seed and some plant particles. One disc is stationary and the other spins. The discs need to be adjusted so the space between them will mill the smallest size weed seed in that field. An auger is necessary to force the weed seed into the mill because if it is wet it will get gooey and plug the mill rather than flow through. Wet seed and plant particles are typical at harvest because the weeds are not all ripe yet. After the weed seed is milled it can be allowed to drop on the ground.

2. The apparatus of claim 1, a hopper to catch and store excess weed seed while the mill catches up.

3. The apparatus of claim 1, An auger forces the weed seed into the mill.

4. The apparatus of claim 1, The mill grinds the weed seed into flour.
